(19) United States
(12) Patent Application Publication
(10) Pub. No.: US 2013/0075355 A1
(43) Pub. Date: Mar. 28, 2013

(54) CONTAINER HAVING A THREADED CLOSURE SLEEVE

(71) Applicant: Pascal Probst, Metzerlen (CH)

(72) Inventor: Pascal Probst, Metzerlen (CH)

(21) Appl. No.: 13/700,250

(22) PCT Filed: May 27, 2011
(86) PCT No.: PCT/EP2011/002618

§ 371 Date: Dec. 13, 2012

(30) Foreign Application Priority Data
May 27, 2010 (CH) 00838/10

(51) Int. Cl. B65D 1/02; B21D 51/26; B21D 51/44; B23P 19/02

(52) U.S. Cl. CPC B65D 1/0246; B23P 19/02; B21D 51/2638; B21D 51/44
USPC 215/44; 29/508; 72/370.1; 72/379.4

(57) ABSTRACT

A container includes a container space and a dispensing neck having a dispensing opening and comprising a substantially round cross-section and on which a fastening device is provided for fastening a closure cap over the dispensing opening, wherein said container comprises an outer sleeve that is rigidly disposed on the dispensing neck. The fastening device is formed on the outer sleeve. The outer sleeve is placed at least partially over the dispensing neck. The outer circumference of the dispensing neck is pressed onto an inner circumferential surface of the outer sleeve.

### TECHNICAL AREA

The present invention relates to a container, in particular a container for holding liquids, such as a bottle for example, in particular for holding products of the pharmaceutical, fragrance and chemical industries.

### PRIOR ART

Containers for holding liquids are widely known from the packaging industry for food products and for pharmaceutical and chemical products. Plastic, glass or metal bottles are generally used. The neck of the bottle is usually cylindrical, ending in an annular dispensing opening. A variety of systems for sealing the bottles are known, such as a stopper in the form of cork, or screw closures. For screw closures, bottles generally have an external threading at the neck of the bottle, onto which a cap can be screwed. The external threading is integrated into the outer surface of the bottle, for example as the bottle is formed either through casting or injection molding. For plastic bottles, this is done through injection molding, for example. For bottles made of INOX materials, the threading is cut into the bottle through a milling operation.

When a liquid is poured out of this kind of conventional bottle, the edge of the dispensing opening forms a kind of step for the liquid stream, the step causing small amounts of the liquid to remain behind outside the edge of the opening after pouring, resulting in the liquid dripping off or flowing down the outside of the bottle when the bottle is placed upright, thereby contaminating the closure area, the bottle and the environment thereof. In particular, when measuring out small amounts of a liquid, as is frequently required for chemical or pharmaceutical products, drops remain behind on the opening of the bottle and lead to considerable losses and contamination. Such left-over dripping depends on the shape of the dispensing opening and on the size of the step, and therefore also on the wall thickness of the bottle's neck, as well as the configuration of the outer threads in this area.

Therefore, the prior art includes known pouring aids for bottles to keep contamination of the outside of the bottle, and thus unnecessary losses, from happening. For example, thin, rolled film plates are placed in the opening of the bottle so that they form a sharp separating edge for the liquid when it is poured. To close the bottle, these pouring aids must be removed from the neck of the bottle so that the closure can be attached to the opening.

A device is known from U.S. Pat. No. 6,609,639 Bl for preventing left-over dripping during pouring from a bottle, the device being designed as a sleeve and being placeable over the outside of the dispensing opening at the neck of a bottle. The device comprises a stop that extends inward, the edge of the bottle's neck abutting the stop. A seal for sealing the gap between the device and the bottle is placed at the inner perimeter. Above the stop is an spout area with a curved inner wall so that the edge of the spout over which the liquid runs when it is poured bulges outward. A threading is provided at the outer perimeter beneath the bulge, the threading being disposed at a projection such that the threading can protrude radially past the bulged edge. A closure cap can be screwed on the threads, the cap covering the opening and the edge. This kind of device has a complicated design and is only suited for larger bottle openings.

A collar is known from U.S. Pat. No. 6,010,026 with a plastic sleeve provided at the neck area thereof, the sleeve having a threading for a cover. The plastic sleeve is pushed over a neck of the collar, whereupon the edge of the collar is bent down until the plastic sleeve sits solidly. To prevent the plastic sleeve on the collar from rotating, ribs and grooves can be provided on the collar and the plastic sleeve, the ribs and grooves meshing together.

Known from WO 2006/050620 Al is a container unit comprising a thread-less container and a sleeve-like closure element. The closure element is designed as a threaded ring and is placed over the neck of the container. Then, the edge of the container is crimped over the threaded ring. The outside of the threaded ring abuts flush with the dispensing opening of the container. In order to fasten the threaded ring rigidly to the container, longitudinal ribs are provided on the inside, the ribs meshing with a tooth structure at the container.

Document US 2005/0142311 Al discloses a container with a threaded sleeve on which the container neck is fastened. The threaded sleeve sits on a ledge at the container neck. It is fastened by bending an outer flange of the container neck over the sleeve.

### OBJECT OF THE INVENTION

One object of the present invention is to provide a container that largely suppresses left-over dripping, prevents contamination of the outside of the bottle and unnecessary product loss, the container reliably protecting the contents thereof and being simple and cost-effective to manufacture.

A further object of the invention is to provide a method for manufacturing a container, the method needing few work steps, ensuring reliable and precise shaping of the dispensing area of the container, being suitable for different types of containers and able to be inexpensively designed.

### ILLUSTRATION OF THE INVENTION

This object is achieved by a container according to claim 1 and a method for manufacturing a container according to claim 13. Advantageous embodiments are described in the dependent claims.

A container, in particular for the safekeeping of liquids, according to the present invention comprises a container space and a dispensing neck with a dispensing opening. The dispensing neck has a substantially round cross section, in other words a round or circular outer perimeter where a fastening device for fastening a closure cap over the dispensing opening is provided. The container space is preferred to be cylindrical, similar to a conventional bottle, but can also have a rectangular or other kind of cross section. The container space is determined substantially by the internal volume of the container. The dispensing opening is provided at the end of the dispensing neck, which protrudes out from the container space as a sleeve-like extension, for example. The dispensing neck is preferred to have a smaller diameter than the container space. The fastening device at the dispensing neck services to fasten a closure cap over the dispensing opening and to be able to seal the container, preferably airtight.

According to the present invention, an outer sleeve is provided at the outer perimeter of the dispensing neck of the container, the outer sleeve being rigidly attached at the outer perimeter. The fastening device is designed at the lateral outer surface of the outer sleeve. The container is thus made up of a container body that comprises the container space and the dispensing neck, the outer sleeve and optionally a closure cap placed thereon. The outer sleeve thus constitutes a special part which supports the fastening device.

The fastening device is preferred to be provided as an outer threading that interacts with an inner threading on a closure cap. It is preferable for the closure cap to be designed as a sleeve with a closed end and to have the inner threads at the inner perimeter. The outer threads are preferred to be designed to encircle the entire perimeter of the outer sleeve. However, it is also possible to provide only thread sectors that only extend over part of the perimeter, for example at two diagonally opposite quadrant sectors. In principle, other kinds of fastening devices for holding the closure cap in place on the container can be used, for example a snap-on closure in which the closure cap can be elastically snapped into place.

The container is preferred to be made of metal, more preferably of aluminum, and in particular 99.5% aluminum. In this case, the contents of the container is protected from light and against breakage. However, containers made of plastic or glass can also be used. The outer sleeve is preferred to be made of plastic.

According to one embodiment of the present invention, a dispensing lip is formed at an edge of the dispensing neck, the lip protruding in the radial direction beyond the outer sleeve at least partially and enabling liquid to be dispensed from the container. The dispensing neck thus transitions to a dispensing lip at least in some peripheral areas, the lip bending over the edge of the outer sleeve. Thus, a liquid does not come into contact with the outer sleeve when it is poured. It is preferable for the dispensing lip to extend annularly around the entire perimeter of the dispensing opening. The edge of the dispensing neck is thus bent out around the entire perimeter such that it protrudes radially over the edge of the outer sleeve. A liquid can thus be poured out from the dispensing neck at any point. The bend of the dispensing neck is shaped in such a way that it is possible to dispense the liquid from the container in a non-dripping fashion. It is preferable for an outer edge of the dispensing lip to have a smaller radius than an outer radius of the outer threads of the outer sleeve, relative to a center axis of the dispensing neck. The edge of the dispensing lip, or the edge of the dispensing neck bent outward over the outer sleeve, respectively, thus does not protrude radially over the threads of the outer sleeve. This allows a closure cap to be screwed on without being hindered by the dispensing lip. It is advantageous in the process if the radius of the outer edge of the dispensing lip at most equals a core radius of the outer threads of the outer sleeve. An inner threading of a closure cap can then fully mate with the outer threads of the outer sleeve, in other words all the way to a groove between two sides of the thread, without being hindered by the dispensing lip.

It is preferable for a transition from the inner peripheral surface of the dispensing neck to the surface of the dispensing lip to be designed not as a sudden angle, but for it to have a profile that is at least approximately continuous, i.e. a rounding. To accomplish this, the transition can be flattened or rounded. The transition can also be made up of a plurality of transfer surfaces one after the other that are slightly angled relative to one another and which together form a rounded transition.

The outer sleeve can be solidly disposed on the dispensing neck either through a frictional lock or through positive locking. In the process, it is important that the outer sleeve does not rotate relative to the container when a closure cap is screwed on or off, in other words when the effect of a torque normally required for this purpose is applied. In the case of a frictionally locked arrangement of the outer sleeve on the dispensing neck, the dispensing neck is pressed against the lateral inner surface of the outer sleeve in such a way that rotation is not possible. Alternatively, the outer sleeve can have on the inner peripheral surface thereof at least one recess for attaching the outer sleeve to the dispensing neck. The outer peripheral surface or a projection on the outer peripheral surface of the dispensing neck can at least partially mate with the recess. The projection mates with the recess in such a way that tilting and rotating between the outer sleeve and the dispensing neck are prevented.

The outer perimeter of the container can have at least one positioning stop for positioning the outer sleeve relative to the dispensing opening. The outer sleeve can butt against a back-stop or the lower edge thereof can butt against the positioning stop before it is fastened to the dispensing neck, so that the sleeve sits in a pre-determined position on the container and assumes a defined position relative to the edge of the dispensing neck. The positioning stop acts as a stop of motion of the outer sleeve along the axis of the dispensing neck when the outer sleeve is placed over the dispensing neck. The positioning stop can, for example, be provided by a transition of the dispensing neck, which has a small diameter relative to the container space which has a larger diameter. However, an alternative is to provide a ledge at the outer surface of the container, against which the outer sleeve sits when it is slid over the dispensing neck. According to the invention, such a container is manufactured by placing an outer sleeve over the container or over the dispensing neck and then pressing the outer perimeter of the dispensing neck against an inner peripheral surface of the outer sleeve. In the process, a preferably friction-locked connection of the outer sleeve and the container is achieved so that the outer sleeve is disposed rigidly on the dispensing neck through friction. Then, the edge of the dispensing neck can be shaped radially outward over the edge of the outer sleeve at least partially, or at least in places, to form a dispensing lip. Preferably, the entire perimeter of the edge is ported outward so that an annular dispensing lip results which is bend over the edge of the outer sleeve. The dispensing lip is preferred to be bent such that drip-less dispensing results.

It is preferred for the dispensing neck of the container to be shaped through mechanical cold-working, for example using a rolling tool acting on the lateral inner surface of the dispensing neck through the force of pressure, thereby widening and bending it out, or porting it. To achieve this, rolls of the rolling tool can introduced into the dispensing neck parallel to the axis thereof and can widen the inner perimeter of the dispensing neck by way of pressure and press the outer surface thereof against the outer sleeve. If recesses are provided at the inner surface of the outer sleeve, the rolls can also press the outer surface of the dispensing neck into the recesses, at least partially. This creates a positive-locked arrangement of the outer sleeve at the dispensing neck. Also, rolls that are tilted relative to the axis of the dispensing neck can be used to port the edge of the dispensing neck radially outward, at least partially. In the process, rolls of different tilt angles, or rolls that move in different tilt angles, can also be used. This allows an at least approximately continuous profile, or a type of rounding to be designed into the transition from the inner peripheral surface of the dispensing neck to the surface of the dispensing lip.

In the case of a container made of aluminum, the dispensing neck thereof can be pressed against the outer sleeve in a simple manner using the rolling tool. However, other metals can also be used, such a brass or copper.

A container according to the present invention, comprising an outer sleeve near the dispensing neck, has the advantage that the fastening device, for example the outer threading, and the shape of the pouring edge can be produced independent of the manufacture of the container. The fastening device and the pouring edge can therefore be individually tailored to the container based on different requirements, for example

based on special liquid characteristics of a liquid. At the same time, the pouring edge can be designed for a closure cap independent of the configuration of the fastening system and can be designed according to the criteria of optimum dispensing of the liquid from the container. For example, an separation edge such as a dispensing lip, can be formed which ensures drip-less dispensing for a specific liquid with defined characteristics.

In another embodiment, the outer sleeve can protrude over an edge of the dispensing opening and can form a dispensing edge for pouring a liquid located in the container. In the process a transition from the edge of the dispensing opening to the outer sleeve is preferably designed to be at least nearly smooth at the inside of the container. To this end, the dispensing neck can be widened such that the inner diameter of the outer sleeve at least approximately equals the inner diameter of the dispensing opening of the dispensing neck in the installed state.

An alternative to pressing the dispensing neck against the inner peripheral surface of the outer sleeve is to press an outer sleeve against the lateral outer surface of the dispensing neck. For example, when using an outer sleeve made of aluminum. In the process, the outer threads can at the same time be made by way of pressure from the outside, such as by using a rolling tool, on the lateral outer surface of the outer sleeve.

### BRIEF DESCRIPTION OF THE DRAWINGS

A preferred embodiment of the invention is illustrated with the help of the following drawings, which are only for explanatory purposes and should not be interpreted as being limiting. Features of the invention that are disclosed in the drawings should be viewed as being part of the disclosure of the invention individually and in any combination. Shown in the drawing are:

FIG. 1 a schematic representation of a first embodiment of a container with an outer sleeve placed thereon according to the present invention and

FIG. 2 a schematic representation of a second embodiment of a container according to the invention with a closure cap.

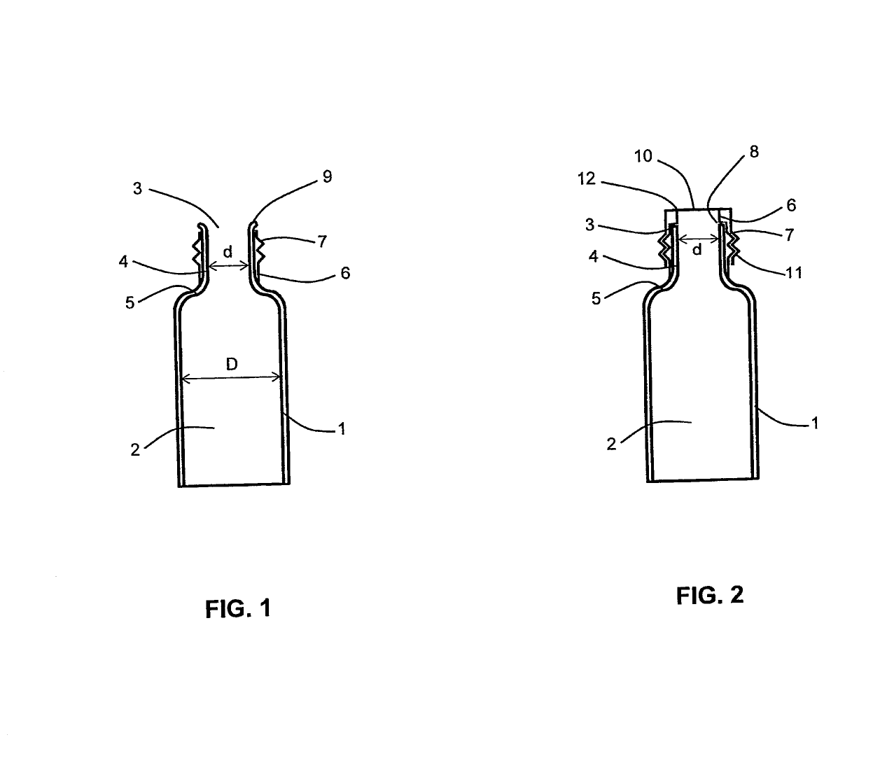

FIG. 1 shows a container in the form of a bottle 1 with a container space 2 for holding a liquid and a dispensing opening 3 designed at a dispensing neck 4 that connects to the container space 2, in other words a bottle neck, the liquid able to be poured out through the dispensing opening. The container space 2 has a first diameter D that is larger than a second diameter d of the dispensing neck 4. In the transition between the larger diameter D and the smaller diameter d, a shoulder 5 is formed in the wall of the bottle 1. An outer sleeve 6 is placed over the dispensing neck 4, the sleeve surrounding the bottle neck 4. The outer sleeve 6 ends below the dispensing opening 3 so that the dispensing neck 4 penetrates completely through the outer sleeve 6 and so that the dispensing opening 3 protrudes out of the same. Provided at the outer sleeve 6 is an outer threading 7. The shoulder 5 serves as a positioning stop for the outer sleeve 6 so that the outer sleeve is disposed in a defined position relative to the bottle 1. The edge of the dispensing neck 4 is bent radially outward over the outer sleeve 6 and forms a dispensing lip 9.

As seen in the figure, the dispensing lip is designed around the entire perimeter of the dispensing opening in a circular, or annular, fashion. The transition from the inner peripheral surface of the dispensing neck 4 to the surface of the dispensing lip 9 has an at least approximately continuous profile, which in FIG. 1 is shown schematically as a rounding. However, the profile of the transition can be tailored to the specific flow characteristics of a liquid held in the bottle 1, for example the transition can also comprise one or more edges that are arranged together in steps and that form the bend of the outer sleeve 6.

In FIG. 1, a smaller distance between the outer wall of the dispensing neck 4 and the inner wall of the outer sleeve 6 is shown for the sake of simplicity. However, according to the invention, the outer lateral surface of the dispensing neck 4 after widening, for example by way of a rolling tool, sits at least mostly against the inner surface of the outer sleeve 6. The outer sleeve 6 is attached mechanically to the dispensing neck 4 so that rotation between the outer sleeve 6 and the bottle 1 is prevented. The friction-locking is strong enough to counteract any manual rotation of the outer sleeve 6 on the bottle 1. Thus, a closure cap, as is shown in FIG. 2 for example, can be solidly screwed onto the outer sleeve 6 without the outer sleeve 6 rotating on the bottle 1.

Shown in FIG. 2 is a second embodiment of a container according to the invention in which an outer sleeve 6 extends beyond the edge of the dispensing neck. The area of the outer sleeve 6 that extends beyond the dispensing opening 3 was compressed until the inner diameter of the outer sleeve 6 equals the inner diameter d of the bottle neck 4. The result is a substantially continuous and seamless transition 8 between the bottle 1 and the outer sleeve 6. In this state of the outer sleeve 6, that of being solidly mounted on the bottle 1, the upper edge of the outer sleeve 6 forms an edge 12 as a separation edge for pouring the liquid out of the bottle 1.

Further shown in FIG. 2 is a closure cap 10 with an inner threading 11, the cap being screwed onto the outer threading 7 of the outer sleeve 6. An inner surface of the closure cap 10 can sit on the edge 12 of the outer sleeve 6 and thereby seal the bottle 1 airtight. In theory, a sealed closure can also be achieved solely using the mating threads.

The closure cap 10 shown in FIG. 2 is also suited for being screwed onto a container according to the embodiment shown in FIG. 1. If a closure cap 10 is screwed onto the outer threads 7 of the outer sleeve 6, the surface of the dispensing lip 9 can sit against the inner surface of the closure cap 10, and thereby seal the bottle 1 airtight.

### REFERENCE LIST

1 Container
2 Container space
3 Dispensing opening
4 Dispensing neck
5 Shoulder
6 Outer sleeve
7 Outer threading
8 Transition
9 Dispensing lip
10 Closure cap
11 Inner threading
12 Edge
D Diameter of container space
d Diameter of dispensing neck

1. A container comprising a container space and a dispensing neck with a dispensing opening, the neck having a substantially round cross section and a fastening device for fastening a closure cap over the dispensing opening, characterized in that, an outer sleeve is disposed at the outer perimeter of the dispensing neck, the sleeve being rigidly attached to the outer perimeter of the dispensing neck and the fastening device being disposed on the sleeve, wherein the outer sleeve is disposed on the dispensing neck in a friction-locked manner such that the dispensing neck is pressed against a lateral inner surface of the dispensing sleeve.

2. The container according to claim 1, characterized in that the fastening device is provided by way of an outer threading.

3. The container according to claim 1, characterized in that the container is made of metal and the outer sleeve is made of plastic.

4. The container according to claim 1, characterized in that a dispensing lip is provided at the edge of the dispensing neck, the lip protruding at least partially in the radial direction beyond the outer sleeve.

5. The container according to claim 4, characterized in that, the dispensing lip extends annularly around the entire perimeter of the dispensing opening.

6. The container according to claim 4, characterized in that an outer edge of the dispensing lip has a smaller radius than an outer radius of the outer threads of the outer sleeve based on a middle axis of the dispensing neck.

7. The container according to claim 4, characterized in that the radius of the outer edge of the dispensing lip at most equals a core radius of the outer threads of the outer sleeve.

8. The container according to claim 4, characterized in that a transition from the inner peripheral surface of the dispensing neck to the surface of the dispensing lip has an at least approximately continuous profile.

9. The container according to claim 1, characterized in that the outer sleeve at the inner peripheral surface comprises at least one recess with which the outer peripheral surface of the dispensing neck at least partially mates.

10. The container according to claim 1, characterized in that at least one positioning stop is provided at the outer perimeter of the container, the stop providing positioning of the outer sleeve relative to the container.

11. A method for manufacturing a container comprising a container space and a dispensing neck with a dispensing opening, the neck having a substantially round cross section and comprising a fastening device, characterized by the steps of:
placing an outer sleeve over the outer perimeter of the dispensing neck, and
pressing the outer perimeter of the dispensing neck against an inner peripheral surface of the outer sleeve, whereupon the dispensing neck sits against the outer sleeve in friction-locked fashion.

12. The method according to claim 11, characterized in that the dispensing neck is pressed against the inner peripheral surface of the outer sleeve by way of cold forming.

13. The method according to claim 11, characterized in that the edge of the dispensing neck is shaped at least partially radially outward around the outer sleeve to form a dispensing lip.

14. The method according to claim 11, characterized in that the dispensing lip is ported by way of cold forming.

15. The method according to claim 11, characterized in that the shaping of the dispensing neck is accomplished by way of a rolling tool that acts on the dispensing neck by way of a mechanical force.

16. The method according to claim 11, characterized in that an at least approximately continuous profile is designed into the transition of the inner peripheral surface of the dispensing neck to the surface of the dispensing lip by way of widening the inner perimeter of the dispensing neck using the rolling tool using rolls that are disposed parallel to the axis of the dispensing neck, and by way of porting the edge of the dispensing neck at least partially radially outward using rolls that re tilted relative to the axis of the dispensing neck.
